(19) United States
(12) Patent Application Publication
(10) Pub. No.: US 2026/0037903 A1
(43) Pub. Date: Feb. 5, 2026

(54) SYSTEMS, APPARATUSES, METHODS, AND COMPUTER PROGRAM PRODUCTS FOR CATEGORIZING PID ASSET PERFORMANCE IN A MULTI-LAYERED ENTERPRISE SYSTEM

(71) Applicant: Honeywell International Inc., Charlotte, NC (US)

(72) Inventors: Rajeeva Naduthota Manjunatha, Bangalore (IN); Sriram Hallihole, Bengaluru (IN); Ranjeet Das, Bangalore (IN); Sudhakar Kathari, Bangalore (IN); Shivanky Jaiswal, Bengaluru (IN)

(21) Appl. No.: 18/794,614

(22) Filed: Aug. 5, 2024

(51) Int. Cl. G06Q 10/0639

(52) U.S. Cl. CPC G06Q 10/06393

(57) ABSTRACT

Embodiments of the present disclosure relate to categorizing PID controllers. Performance diagnostic data for a PID controller may be generated by applying KPI data for the PID controller to one or more performance diagnosis rules. Performance issue classification for the PID controller may be generated based on the performance diagnostic data. Performance rating classification for the PID controller may be generated based on performance rating data for the PID controller. An improvement action for the PID controller may be generated based on the performance issue classification and the performance rating classification for the PID controller. Performance of one or more prediction-based actions may be initiated based on the improvement action.

### TECHNICAL FIELD

The present disclosure relates, generally, to monitoring proportional-integral-derivative (PID) assets. Example embodiments provide systems, apparatuses, methods, and computer program products for categorizing PID asset performance in a multi-layered enterprise system.

### BACKGROUND

In various contexts, processing facilities are often managed using process control and automation systems. Many process control and automation systems include multiple hierarchical layers that, individually and/or collectively, include a large number of assets that require continuous monitoring to ensure maximum performance. Applicant has discovered problems with current implementations of monitoring assets in process control and automation systems, including PID assets. Through applied effort, ingenuity, and innovation, Applicant has solved many of these identified problems by developing solutions embodied in the present disclosure, which are described in detail below.

### BRIEF SUMMARY

In accordance with one aspect of the present disclosure, a computer-implemented method for categorizing PID controller performance is provided. The computer-implemented method is executable utilizing any of a myriad of computing device(s) and/or combinations of hardware, software, and/or firmware. In some example embodiments, an example computer-implemented method comprises generating, by one or more processors and using a performance analysis model, performance diagnostic data for a PID controller by applying KPI data for the PID controller to one or more performance diagnosis rules, wherein each performance diagnosis rule is defined at least in part by one or more threshold values for one or more KPIs for the PID controller; generating, by the one or more processors, performance issue classification for the PID controller based on the performance diagnostic data; generating, by the one or more processors, performance rating classification for the PID controller based on performance rating data for the PID controller by applying the performance rating data to one or more performance rating classification rules; generating an improvement action for the PID controller based on the performance issue classification and the performance rating classification for the PID controller by applying the performance issue classification and the performance rating classification to one or more PID categorization rules, wherein the improvement action corresponds to a PID controller category of a plurality of Controller categories; and initiating performance of one or more prediction-based actions based on the improvement action.

In some embodiments, the example method further comprises receiving plant data from one or more process plants, the plant data comprising PID data for the PID controller; and generating the KPI data for the PID controller based on the PID data.

In some embodiments, the example method further comprises generating the performance rating data for the PID controller by comparing each of one or more KPI values from the KPI data to a corresponding threshold value.

In some embodiments, the performance diagnostic data for the PID controller comprises one or more detected faults associated with PID controller.

In some embodiments, the performance analysis model comprises a rules-based model.

In some embodiments, the improvement action is generated using the performance analysis model, where the performance analysis model defines the one or more PID categorization rules.

In some embodiments, the PID controller is associated with one or more of an APC controller or a PWO controller.

In some embodiments, initiating performance of one or more prediction-based operations comprises automatically adjusting one or more of (i) one or more parameters associated with the PID controller, (ii) one or more parameters associated with the APC controller, or one or more parameters associated with the PWO controller.

In some embodiments, initiating the performance of one or more prediction-based operations comprises generating statistical data for each PID controller category of the plurality of Controller categories based on the PID controllers assigned to each PID controller category; and causing rendering of a user interface comprising one or more representation of the statistical data.

In some embodiments, the PID controller is associated with one or more of APC controller or PWO controller.

In accordance with another aspect of the present disclosure, an apparatus for categorizing PID controllers is provided. The apparatus in some embodiments includes at least one processor and at least one non-transitory memory, the at least one non-transitory memory having computer-coded instructions stored thereon. The computer-coded instructions in execution with the at least one processor causes the apparatus to perform any of the example computer-implemented methods described herein. In some other embodiments, the apparatus includes means for performing each step of any of the computer-implemented methods described herein.

In accordance with another aspect of the present disclosure, a computer program product for categorizing PID controllers is provided. The computer program product in some embodiments includes at least one non-transitory computer-readable storage medium having computer program code stored thereon. The computer program code in execution with at least one processor is configured for performing any one or the example computer-implemented methods described herein.

### BRIEF DESCRIPTION OF THE SEVERAL VIEWS OF THE DRAWINGS

Having thus described the embodiments of the disclosure in general terms, reference now will be made to the accompanying drawings, which are not necessarily drawn to scale, and wherein:

FIG. 1A illustrates a block diagram of an example system architecture in which embodiments of the present disclosure may operate.

FIG. 1B illustrates a block diagram of an example process control and automation system in accordance with at least one example embodiment of the present disclosure.

FIG. 2 illustrates a block diagram of an example apparatus in accordance with at least one example embodiment of the present disclosure.

FIG. 3 illustrates a data flow diagram showing example data structures for categorizing PID controller performance in accordance with at least one example embodiment of the present disclosure.

FIG. 4a illustrates an operational example of performance diagnosis classification categories and related features in accordance with at least one example embodiment of the present disclosure.

FIG. 4b illustrates an operational example of performance rating classification categories and related features in accordance with at least one example embodiment of the present disclosure.

FIG. 4c illustrates an operational example of controller categories and related features in accordance with at least one example embodiment of the present disclosure.

FIGS. 5A-B each illustrate an example user interface in accordance with at least one example embodiment of the present disclosure.

FIG. 6 illustrates flowchart including operations of an example process for categorizing PID controller performance in accordance with at least one example embodiment of the present disclosure.

### DETAILED DESCRIPTION

Various embodiments of the present disclosure now will be described more fully hereinafter with reference to the accompanying drawings, in which some, but not all, embodiments of the present disclosure are shown. Indeed, the present disclosure may be embodied in many different forms and should not be construed as limited to the embodiments set forth herein, rather, these embodiments are provided so that this disclosure will satisfy applicable legal requirements.

The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### Overview and Technical Improvements

Various embodiments of the present disclosure are generally directed to systems, apparatuses, methods, and computer program products for monitoring assets associated with a process control and automation system, including PID assets. Example embodiments disclosed herein address technical challenges associated with monitoring process control assets, including PID assets, APC assets, and PWO assets.

In the process industry, effectively monitoring a multitude of assets presents a considerable challenge. Various layers of assets necessitate continuous surveillance to maintain optimal performance. For instance, at the regulatory layer, there is a need for monitoring PID controllers (also referred to interchangeably herein as PID assets) and instruments, while at the advanced control layer, assets such as advance process control (APC) and plantwide optimizer (PWO) require ongoing attention.

Often, the volume of assets that require monitoring is substantial. In a typical site, the regulatory layer alone may include 2500 to 3000 assets that require monitoring. Similarly, within APC, there may be 10 to 15 model predictive control (MPC) assets comprising over 300 variables that require monitoring. Given the impracticality of manual monitoring for each asset and error associated with manual monitoring, there is a need for a consolidated view and an overall performance asset score for prioritizing attention towards critical assets that are pivotal for the process(es) being controlled by the assets.

Moreover, these assets are intricately interconnected. For instance, in a typical PWO scenario, PWO assets may interface with unit-level APC controllers which are connected to instruments (e.g., sensors, control valves, and/or the like) at the regulatory layer. Consequently, any malfunction at the regulatory layer reverberates through to the unit-level APCs and subsequently affects PWO functionality. Accordingly, the root cause of underperforming PWO assets may stem from issues at the regulatory layer, such as poorly performing control valves, or inadequately tuned PID assets. Thus, there is a need to accurately diagnose the root cause and determine actionable insights to empower users to rectify issues promptly so as to ensure effective maintenance of these assets.

Example embodiments of the present disclosure provide for automatically identifying and diagnosing poorly performing PID assets as well as determining, facilitating, and/or executing actionable insights for the poorly performing PID assets. To do so, example embodiments categorize PID assets into multiple categories across a multi-layered enterprise comprising multiple sites. Accordingly, example embodiments of the present disclosure automatically identify different PID issues affecting overall PWO performance, and thus affecting performance of its secondary APCs. By doing so, embodiments of the present disclosure provide for improved monitoring and improved performance of PID assets and, in turn, improved monitoring and performance of APC and PWO assets associated with the PID assets.

Moreover, given the complexity of manually analyzing asset performance across various key performance indicators (KPIs), automatically categorizing these assets (e.g., including PID assets) into different categories according to various embodiments of the present disclosure provide significant value to users. Such significant values include, but is not limited to, providing for more efficient prioritization and action planning, enhancing accountability, and enabling effective tracking of resolution efforts for poorly performing assets

In some embodiments, for each PID controller of one or more PID controllers associated with an enterprise system, performance diagnostic data and performance classification data is generated based on KPI data (e.g., at least a portion of the KPI data) for the PID controller and corresponding threshold data. In some embodiments, for each PID controller of the one or more PID controllers, a performance issue classification is generated based on the performance diagnostic data for the respective PID controller and a performance rating classification is generated based on the performance rating data for the respective PID controller.

In some embodiments, for each PID controller of the one or more PID controllers, an improvement action corresponding to a PID controller category is determined for the PID controller is generated for the PID controller based on the performance issue classification and/or the performance rating classification for the PID controller. In such some embodiments, the improvement action for a PID controller may be selected from a plurality of improvement actions based on the performance issue classification and/or the performance rating classification for the PID controller. In an example embodiment, the plurality of improvement actions comprises tuning, repairing and investigating.

In some embodiments one or more parameters of at least one PID controller is automatically adjusted based on the improvement action determined for the at least one PID controller automatically

In some embodiments, statistical data for each PID controller category of the plurality of controller categories is generated and rendered on a user interface. statistical data may be generated at the various levels associated with the enterprise system. For example, in some embodiments, the statistical data may comprise one or more of unit-level statistical data, plant-level statistical data, site-level statistical data, or enterprise-level statistical data.

In this regard, embodiments of the present disclosure automatically determines the performance rating (e.g., overall health) and performance diagnosis for PID controllers by analyzing or otherwise assessing KPIs for the PID, automatically categorizes PID controllers into multiple categories across a multi-layered enterprise, automatically provides actionable insights for underperforming PID controllers which facilitates remedial actions and improves performance and operational efficiency of the PID controllers, automatically generates user actions based on the performance rating, performance diagnosis, and PID categorizations. Further, certain embodiments, automatically track user actions (e.g., until identified issue(s) for a PID controller has been resolved and/or the PID controller performance has improved to a satisfactory level).

### Definitions

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As used herein, the terms “data,” “content,” “digital content,” “information,” and similar terms may be used interchangeably to refer to data capable of being transmitted, received, and/or stored in accordance with embodiments of the present disclosure. Further, where a computing entity is described herein to receive data from another computing entity, it will be appreciated that the data may be received directly from another computing entity or may be received indirectly via one or more intermediary computing entities, such as, for example, one or more servers, relays, routers, network access points, base stations, hosts, and/or the like, sometimes referred to herein as a “network.” Similarly, where a computing entity is described herein to send data to another computing device, it will be appreciated that the data may be sent directly to another computing entity or may be sent indirectly via one or more intermediary computing devices, such as, for example, one or more servers, relays, routers, network access points, base stations, hosts, and/or the like.

### Example Systems and Apparatuses of the Disclosure

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

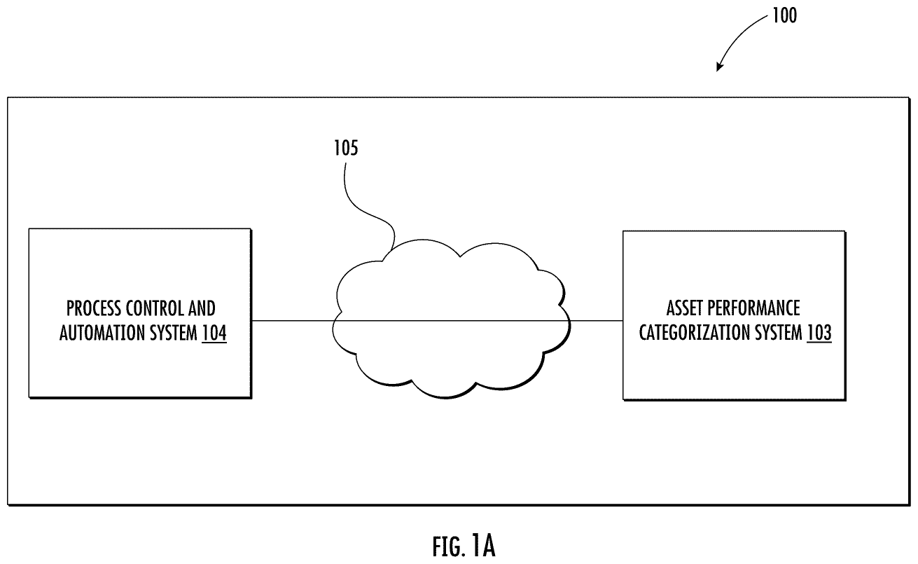

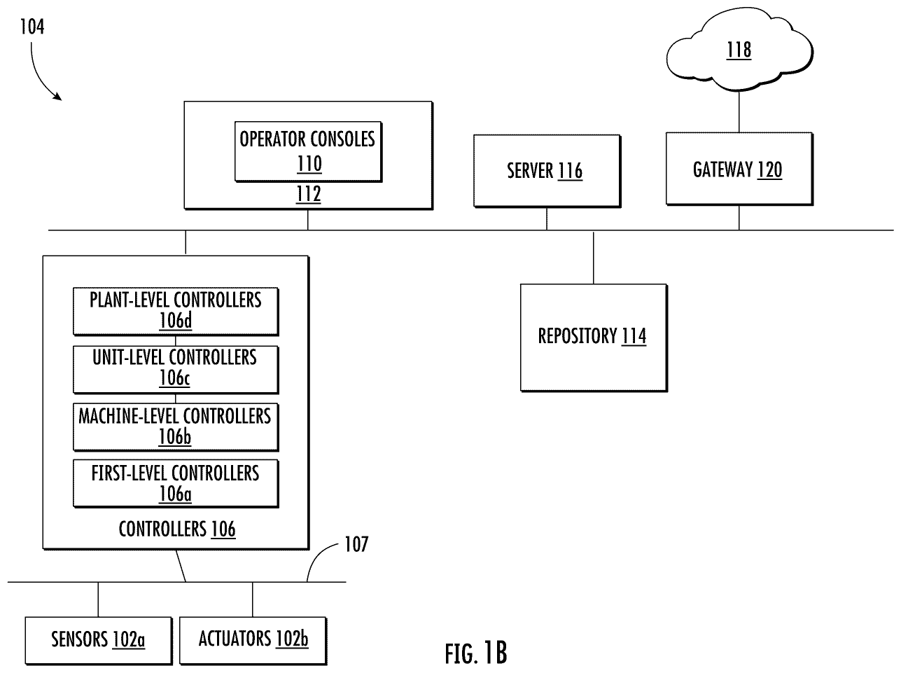

In this regard, FIG. 1A provides an example overview of a system architecture 100 in accordance with at least some example embodiments of the present disclosure. The depiction of the example architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1A and the architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1A are shown as discrete, separate elements, other configurations may be used in connection with the methods, apparatuses, computer readable media, and computer programs described herein, including configurations that combine, omit, separate, and/or add aspects and/or components. The example system architecture 100 may be used in a plurality of domains and not limited to any specific application as disclosed herewith. In particular, while some example embodiments are described herein with reference to industrial plant domain, the example system architecture 100 may be used in a plurality of domains and limited to any specific application as disclosed herein. The plurality of domains may include healthcare, industrial, manufacturing, education, retail, to name a few.

As illustrated, the system architecture 100 includes a process control and automation system 104 in communication with an asset performance categorization system 103. In some embodiments, the process control and automation system 104 communicates with the asset performance categorization system 103 over one or more communications network(s), for example a communications network 105.

It should be appreciated that the communications network 105 in some embodiments is embodied in any of a myriad of network configurations. In some embodiments, the communications network 105 embodies a public network (e.g., the Internet). In some embodiments, the communications network 105 embodies a private network (e.g., an internal localized, or closed-off network between particular devices). In some other embodiments, the communications network 105 embodies a hybrid network (e.g., a network enabling internal communications between particular connected devices and external communications with other devices). The communications network 105 in some embodiments includes one or more base station(s), relay(s), router(s), switch(es), cell tower(s), communications cable(s) and/or associated routing station(s), and/or the like. In some embodiments, the communications network 105 includes one or more user-controlled computing device(s) (e.g., a user owned router and/or modem) and/or one or more external utility devices (e.g., Internet service provider communication tower(s) and/or other device(s)).

Each of the components of the system architecture 100 may be communicatively coupled to transmit data to and/or receive data from one another over the same or different wireless and/or wired networks embodying the communications network 105. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1A illustrate certain system entities as separate, standalone entities communicating over the communications network 105, the various embodiments are not limited to this architecture. In other embodiments, one or more computing entities share one or more components, hardware, and/or the like, or otherwise are embodied by a single computing device such that connection(s) between the computing entities are over the communications network 105 are altered and/or rendered unnecessary. For example, in some embodiments, the process control and automation system 104 includes some or all of the asset performance categorization system 103, such that an external communications network 105 is not required.

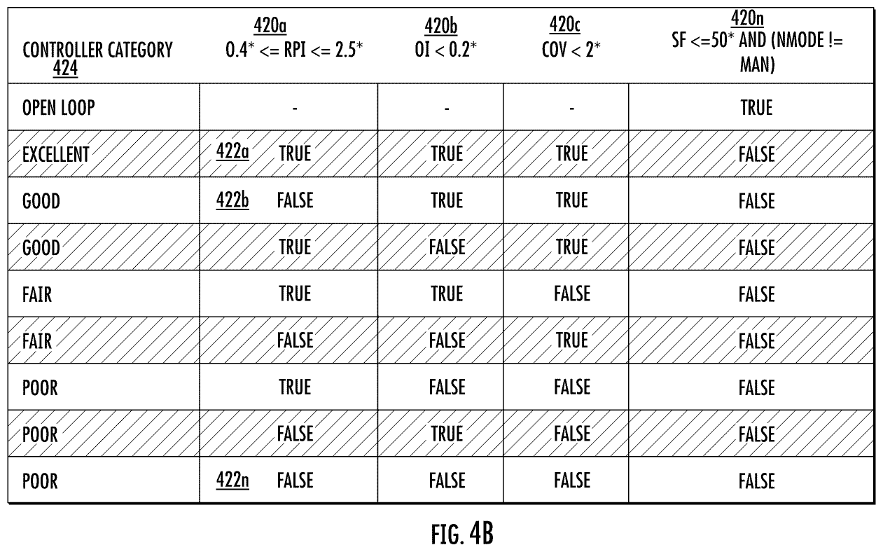

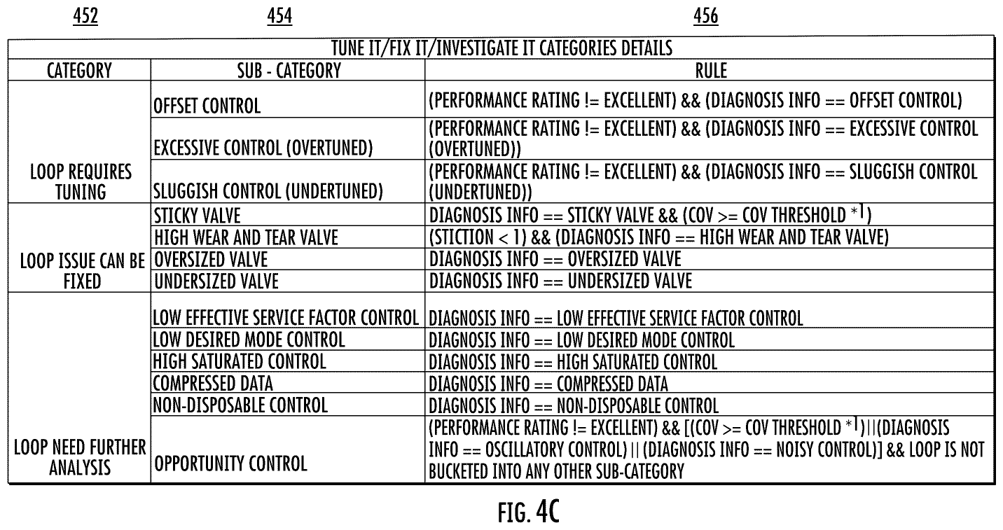

In some embodiments, the process control and automation system 104 is associated with a processing plant. In some embodiments, the process control and automation system 104 and the asset performance categorization system 103 are embodied in an on-premises system within or associated with a processing plant. In some such embodiments, the process control and automation system 104 and the asset performance categorization system 103 arc communicatively coupled via at least one wired connection. Alternatively or additionally, in some embodiments, the process control and automation system 104 embodies or includes the asset performance categorization system 103, for example as a software component of a single enterprise terminal. As further described below, with reference to FIG. 4, the asset performance categorization system 103 is configured to receive plant data (e.g., comprising PID controller data, and/or the like) associated with the process control and automation system 104 and categorize the PID controller(s) associated with the process control and automation system 104 with respect to the performance of the PID controllers.

The process control and automation system 104 includes any number of computing device(s), system(s), physical component(s), and/or the like. In some embodiments, at least a portion of the process control and automation system 104 includes any number of computing device(s), system(s), physical component(s), and/or the like that facilitates producing of any number of products, for example utilizing particular configurations that cause processing of particular inputs available within the process control and automation system 104. In some embodiments, the process control and automation system 104 includes one or more physical component(s), connection(s) between physical component(s), and/or computing system(s) that control operation of each physical component therein. Alternatively or additionally, in some embodiments the process control and automation system 104 includes one or more computing system(s) that are specially configured to operate the physical component(s) in a manner that produces one or more particular product(s) simultaneously. In some embodiments, process control and automation system 104 includes one or more computing device(s) and/or system(s) embodied in hardware, software, firmware, and/or a combination thereof, that configure and/or otherwise control operation of one or more physical component(s) in the processing plant. For example, in some embodiments, such computing device(s) and/or system(s) include one or more programmable logic controller(s), MPC(s), application server(s), centralized control system(s), and/or the like, that control(s) configuration and/or operation of at least one physical component. In some embodiments, the process control and automation system 104 defines one or more hierarchical layers. In an example embodiment, the hierarchical layer comprises a regulatory layer, advanced process control (APC) layer and/or a plant wide optimizer (PWO) layer. The regulatory layer may comprise one or more instruments (e.g., sensors, actuators, or the like), one or more PID controllers (also referred to herein as PID assets), and/or other assets. The APC layer may comprise one or more APC controllers (also referred to herein as APC assets). The PWO layer may comprise one or more PWO controllers (also referred to herein as PWO assets). In various embodiments, the asset performance categorization system 103 is configured to monitor at least a portion of the assets (e.g., at least a portion of the instruments, PID controller(s), APC controller(s), and/or PWO controller(s)) embodied by or otherwise associated with process control and automation system 104. In some embodiments, the hierarchical layers of the process control and automation system may be implemented as a Purdue model (described further below). It will be appreciated that different process control and automation system 104 may include different physical component(s), computing system(s), and/or the like.

FIG. 1B illustrates a block diagram of an example process control and automation system 104 in accordance with at least one example embodiment of the present disclosure. The depiction of the example system 104 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1B disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1B are shown as discrete, separate elements, other configurations may be used in connection with the methods, apparatuses, computer readable media, and computer programs described herein, including configurations that combine, omit, separate, and/or add aspects and/or components.

As shown in FIG. 1B, the example system 104 includes various components that facilitate production or processing of at least one product or other material. For instance, the system 104 can be used to facilitate control over components in one or more process plants (e.g., industrial plants such as oil refineries and/or the like). Each plant may represent one or more processing facilities (or one or more portions thereof), such as one or more manufacturing facilities for producing at least one product or other material. In some examples, each plant may implement one or more industrial processes and may, individually or collectively, be referred to as a process system. A process system generally represents any system or portion thereof configured to process one or more products or other materials.

In FIG. 1B, the example system 104 may include one or more sensors 102a and/or one or more actuators 102b. The sensors 102a and actuators 102b represent components in a process system that may perform any of a wide variety of functions. For example, the sensors 102a could measure a wide variety of characteristics in the process system, such as flow, pressure, or temperature. Also, the actuators 102b could alter a wide variety of characteristics in the process system, such as, for example, valve openings. Each of the sensors 102a includes any suitable structure for measuring one or more characteristics in a process system. Each of the actuators 102b includes any suitable structure for operating on or affecting one or more conditions in a process system.

At least one network 107 is coupled to the sensors 102a and actuators 102b. The network 107 facilitates interaction with the sensors 102a and actuators 102b. For example, the network 107 could transport measurement data from the sensors 102a and provide control signals to the actuators 102b. The network 107 could represent any suitable network or combination of networks. In an example embodiment, the communications network 107 includes an ethernet network, electrical signal network, pneumatic control signal network, and/or the like. In some embodiments, the network 107 may include, without limitation, a wired or wireless Personal Area Network (PAN), Local Area Network (LAN), Metropolitan Area Network (MAN), Wide Area Network (WAN), and/or the like.

The example system 104 may include various controllers 106. The controllers 106 may be used in the example system 104 to perform various functions in order to control one or more industrial processes. For example, a first set of controllers 106a may use measurements from one or more sensors 102a to control the operations of one or more actuators 102b. A second set of controllers 106b may be used to optimize the control logic or other operations performed by the first set of controllers. A third set of controllers 106c could be used to perform additional functions. Each controller 106 includes any suitable structure for controlling one or more aspects of a process/unit or group of processes/units associated with one or more plants. At least some of the controllers 106 may, for example, represent proportional-integral-derivative (PID) controllers or multivariable controllers, such as controllers implementing model predictive control (MPC) or other advanced predictive control (APC). In an example embodiment, each controller 106 may represent a computing device running a real-time operating system, a WINDOWS operating system, or the like.

Operator access to and interaction with the controllers 106 and other components of the system 104 may occur via one or more operator consoles 110. An operator console 110 may comprise computing or communication devices. Each operator console 110 may be used to provide information to an operator and/or receive information from an operator. For example, each operator console 110 may provide information identifying a current state of industrial process to the operator, such as values of various process variables and warnings, alarms, or other states associated with the industrial process. Each operator console 110 may also receive information affecting how the process (e.g., industrial process) is controlled, such as by receiving setpoints or control modes for process variables controlled by the controllers 106 or other information that alters or affects how the controllers 106 control the industrial process. Each operator console 110 includes any suitable structure for displaying information to and interacting with an operator. For example, each operator console 110 may represent a computing device running a WINDOWS operating system or other operating system.

Multiple operator consoles 110 may be grouped together and used in one or more control rooms 112. Each control room 112 may include any number of operator consoles 110 in any suitable arrangement. In some embodiments, multiple control rooms 112 may be used to control an industrial plant, such as when each control room 112 includes operator consoles 110 used to manage a discrete part of the industrial plant.

Each server 116 may comprise a computing device that executes applications for users of the operator consoles 110 or other applications. The applications may be used to support various functions for the operator consoles 110, the controllers 106, or other components of the system 104. Each server 116 may represent a computing device running a WINDOWS operating system or other operating system. It will be appreciated that while shown as being local within the system 104, the functionality of the server 116 may be remote from the system 104. For instance, the functionality of server 116 may be implemented in a computing cloud 118 or a remote server communicatively coupled to the system 104 (e.g., via a gateway 120 or the like)

The system 104 may include a repository 114 and/or one or more servers 116. The repository 114 may be configured to stored various information about the system 104. The repository 114, for example, may store information that is generated by the various controllers 106 during the control of one or more industrial processes. The repository 114 includes any suitable structure for storing and facilitating retrieval of information. Although illustrated as a single component in FIG. 1B, the repository 114 may be located elsewhere in the system 104, or multiple repositories may be distributed in different locations in the system 104.

In some embodiments, the controllers 106 may be associated with a hierarchical architecture, where a given controller is associated with a particular level in the hierarchical architecture. For example, in some embodiments, the system 104 may be implemented using a Purdue model of process control, where the controllers 106 may be associated with a hierarchical architecture/structure. In the Purdue model, “Level 0” may include the one or more sensors 102a and the one or more actuators 102b. In the Purdue model, “Level 1” may include one or more first-level controllers 106a configured to use the measurements from one or more sensors 102a to control the operations of one or more actuators 102b. For example, the one or more first-level controllers 106a may be configured to receive measurement data from one or more sensors 102a and use the measurement data to generate control signals for one or more actuators 102b. The first-level controllers 106a and the one or more sensors 102a and/or one or more actuators may be communicatively coupled via a via network.

In the Purdue model, “Level 2” may include one or more machine-level controllers 106b. The machine-level controllers 106b may perform various functions to support the operation and control of the first-level controllers 106a, sensors 102a, and actuators 102b, which could be associated with a particular piece of industrial equipment (such as a boiler or other machine). For example, the machine-level controllers 106b could log information collected or generated by the first-level controllers 106a, such as measurement data from the sensors 102a or control signals for the actuators 102b. The machine-level controllers 106b could also execute applications that control the operation of the first-level controllers 106a, thereby controlling the operation of the actuators 102b. Alternatively or additionally, the machine-level controllers 106b could provide secure access to the controllers 106b. The one or more machine-level controllers 106b may be communicatively coupled to the first-level controllers 106a, the sensors 102a, and/or the actuators 102b. Each of the machine-level controllers 106b includes any suitable structure for providing access to, control of, or operations related to a machine or other individual piece of equipment. Each of the machine-level controllers 106b may, for example, represent a server computing device running an operating system. Although not shown, different machine-level controllers 106b may be used to control different pieces of equipment in a process system (where each piece of equipment is associated with one or more first-level controllers 106a, sensors 102a, and actuators 102b).

In the Purdue model, “Level 3” may include one or more unit-level controllers 106c. Each unit-level controller 106c is typically associated with a unit in a process system, which represents a collection of different machines operating together to implement at least part of a process. The unit-level controllers 106c may be configured to perform various functions to support the operation and control of components in the lower levels. For example, the unit-level controllers 106c may log information collected or generated by the components in the lower levels, execute applications that control the components in the lower levels, and provide secure access to the components in the lower levels. Each of the unit-level controllers 106c includes any suitable structure for providing access to, control of or operations related to one or more machines or other pieces of equipment in a process unit. Each of the unit-level controllers 106c may, for example, represent a server computing device running an operating system. Different unit-level controllers 106c may be used to control different units in a process system (where each unit is associated with one or more machine-level controllers 106b, first-level controllers 106a, sensors 102a, and/or actuators 102b).

In the Purdue model, “Level 4” may include one or more plant-level controllers 106d. Each plant-level controller 106d may be associated with one or more process plants, which may include one or more process units that implement the same, similar, or different processes. The plant-level controllers 106d perform various functions to support the operation and control of components in the lower levels. For example, the plant-level controllers 106d may be configured to execute one or more manufacturing execution system (MES) applications, scheduling applications, or other additional plant or process control applications. Each of the plant-level controllers 106d includes any suitable structure for providing access to, control of or operations related to one or more process units in a process plant. Each of the plant-level controllers 106d may, for example, represent a server computing device running a MICROSOFT WINDOWS operating system. Access to the plant-level controllers 106d may be provided by one or more operator consoles.

In the Purdue model, “Level 5” may include one or more enterprise-level controllers (not shown). Each enterprise-level controller may be configured to perform planning operations for multiple process plants and to control various aspects of the plants. The enterprise-level controllers may also perform various functions to support the operation and control of component in the plants. As particular examples, the enterprise-level controller may be configured to execute one or more order processing applications, enterprise resource planning (ERP) applications, advanced planning and scheduling (APS) applications, or any other or additional enterprise control applications. Each of the enterprise-level controllers may include any suitable structure for providing access to, control of, or operations related to control of one or more process plants. Each of the enterprise-level controllers may, for example, represent a server computing device running an operating system. As used herein, the term enterprise may refer to an organization having one or more process plants or other processing facilities to be managed. It would be appreciated that if a single process plant is to be managed, the functionality of the enterprise-level controller may be incorporated into a plant-level controller 106d. Access to the enterprise-level controllers may be provided by one or more operator consoles. As described above, the operator console may include any suitable structure for supporting user access and control of one or more components in the system 104.

Various levels of the Purdue model can include other components, such as one or more repositories. The repository(s) associated with each level could store any suitable information associated with that level or one or more other levels of the system 104. A repository may, for example, store information used during production scheduling and optimization.

In some embodiments, the various controllers 106 and operator consoles in FIG. 1B may comprise computing devices. For example, each of the controllers 106 (106a-106c) may include one or more processing devices and/or one or more memories for storing instructions and data used, generated, or collected by the processing devices. Each of the controllers 106 may also include at least one network interface, such as one or more Ethernet interfaces or wireless transceivers. Also, each of the operator consoles may include at least one network interface, such as one or more Ethernet interfaces or wireless transceivers.

In some embodiments, at least one component of the system 104 may be configured to support a mechanism (e.g., a system, apparatus, or the like) for asset monitoring. For example, the functionality may be implemented in an operator console 110, a server, or a computing cloud 118 or a remote server. The functionality may be configured for monitoring APC assets (and/or other assets) to, for example, ensure maximum performance of the assets In some embodiments, an asset represents any hardware, software, or other physical or virtual component within a process control and automation system, or an underlying industrial process being controlled. An asset may be associated with a single industrial site (or a portion thereof), multiple industrial sites (or portions thereof), or an enterprise. An asset may include a controller 106 (e.g., 106a-106c). In an example embodiment, an asset describes a controller 106 (e.g., any of controllers 106a-106c).

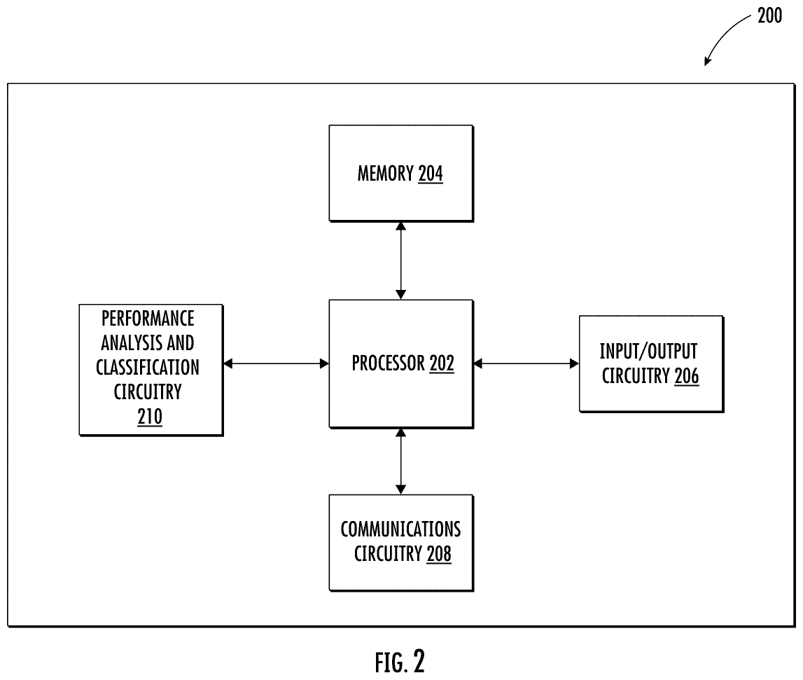

FIG. 2 illustrates a block diagram of an example apparatus that may be specially configured in accordance with at least one example embodiment of the present disclosure. Specifically, FIG. 2 depicts an example asset performance categorization apparatus 200 (“apparatus 200”) specially configured in accordance with at least some example embodiments of the present disclosure. In some embodiments, the asset performance categorization system 103 and/or a portion thereof is embodied by one or more system(s), such as the apparatus 200 as depicted and described in FIG. 2. The apparatus 200 includes processor 202, memory 204, input/output circuitry 206, communications circuitry 208, and/or performance evaluation circuitry 210. In some embodiments, the apparatus 200 is configured, using one or more of the sets of circuitry embodied by processor 202, memory 204, input/output circuitry 206, communications circuitry 208, and/or performance evaluation circuitry 210, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed. As one particular example embodiment, the processor 202 is configured to perform various operations associated with performing improved asset monitoring associated with a process control and automation system.

In some embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more asset(s) or accompanying sensor(s), and/or other external computing device in communication with the apparatus 200.

In some embodiments, the apparatus 200 includes a performance analysis and classification circuitry 210. The performance analysis and classification circuitry 210 includes hardware, software, firmware, and/or a combination thereof, that supports categorizing of PID controllers associated with a process control and automation system. For example, in some embodiments, the performance evaluation circuitry 210 includes hardware, software, firmware, and/or a combination thereof, configured to, with the processing circuitry 202, input/output circuitry 206 and/or communications circuitry 208, perform one or more functions associated with the categorizing PID controller. In some embodiments, the performance evaluation circuitry 210 includes a separate processor, specially configured field programmable gate array (FPGA), or a specially programmed application specific integrated circuit (ASIC).

Alternatively or additionally or in some embodiments, one or more of the sets of circuitries embodying processor 202, memory 204, input/output circuitry 206, communications circuitry 208, and/or performance evaluation circuitry 210. perform some or all of the functionality described as associated with another component. For example, in some embodiments, two or more of the sets of circuitry embodied by processor 202, memory 204, input/output circuitry 206, communications circuitry 208, and/or performance evaluation circuitry 210, are combined into a single module embodied in hardware, software, firmware, and/or a combination thereof. Similarly, in some embodiments, one or more of the sets of circuitry, for example performance evaluation circuitry 210, is/are combined with the processor 202, such that the processor 202 performs one or more of the operations described above with respect to each of these sets of circuitry embodied by the performance evaluation circuitry 210.

### Example System Operations

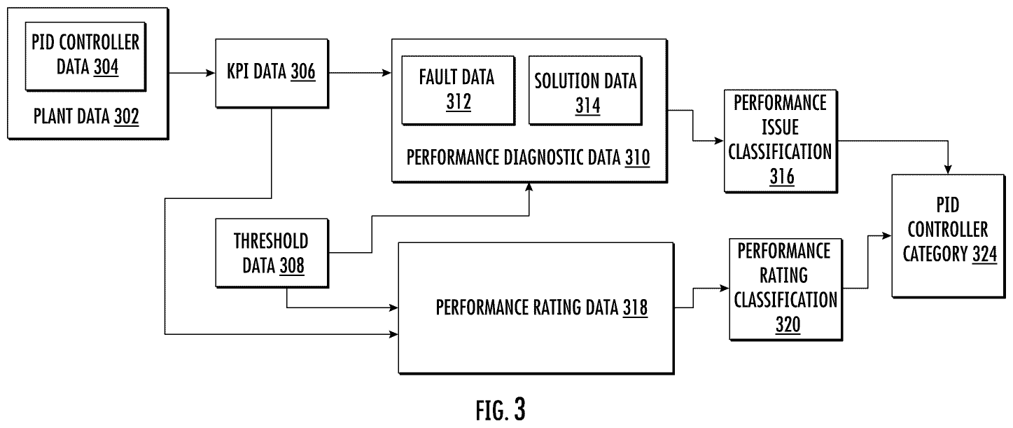

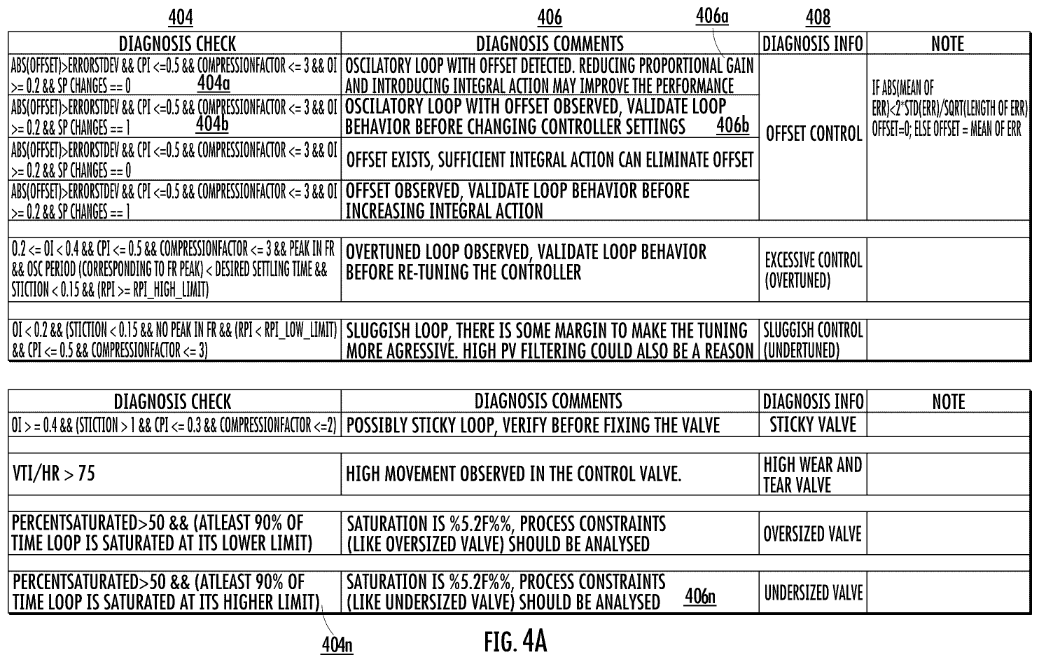

FIG. 3 is a data flow diagram showing example data structures for categorizing PID asset performance in accordance with at least one example embodiment of the present disclosure. In particular, FIG. 3 is a data flow diagram showing example data structures for categorizing PID controllers based on the performance (e.g., health) of the PID controller. In various embodiments, the asset performance categorization system 103 is configured to receive plant data (e.g., comprising PID controller data, and/or the like) associated with the process control and automation system 104 and categorize the PID controller(s) associated with the process control and automation system 104 with respect to the performance of the PID controllers. While aspects of the data flow diagram showing example data structures for categorizing PID asset performance are described below with respect to a single PID controller, the system 103 is configured to categorize one or more PID assets (e.g., PID controllers). For example, the system 103 may perform and/or facilitate the performance of the system operations described below for multiple PID controllers associated with a process plant or group of process plants associated with an enterprise (e.g., enterprise system).

In some embodiments, plant data 302 associated with a process plant is received. The system 103 may receive the plant data 302 from the process control and automation system 104 associated with a process plant. The process plant may be associated with an enterprise system. An enterprise system may be defined at least in part by an enterprise operational hierarchy comprising unit level, plant level, site level, and enterprise level. The unit level may comprise one or more units (e.g., plant equipment/unit configured to output one or more intermediate or finished products). The plant level may comprise one or more process plants, where each process plant comprises one or more units (e.g., plant equipment). The site level may comprise one or more sites, where each site comprises one or more process plants. The enterprise level, in turn, may comprise one or more sites. In some embodiments, the operational hierarchy may further include an area level above the unit level but below the plant level. In various embodiments, the system may receive plant data 302 for each of one or more process plants associated with the enterprise system.

In various embodiments, at least a portion of the plant data 302 comprise PID controller data for each of one or more PID controllers associated with the process plant. In various embodiments, the PID controller data is associated with the process control and automation system 104 associated with the process plant or otherwise originate from the process control and automation system 104. Non-limiting examples of PID controller data include process value data, set point data, instrument input data (e.g., data/command provided by the PID controller to an instrument associated with the PID controller and being controlled by the PID controller). Non-limiting examples of such instruments include sensors, control valves, actuators, or the like.

In various embodiments, KPI data 306 for a PID controller is generated based on the plant data 302 (e.g., PID controller data 304 thereof). In various embodiments, the KPI data 306 comprises one or more calculated KPIs values for the PID controller (e.g., KPI values for one or more KPIs). Non-limiting examples of KPIs for a PID controller include compression factor, oscillation index (OI), set point (SP) changes, relative performance index, percent saturation, service factor (SF), effective service factor (ESF), stiction, and/or the like.

In some embodiments, generating the KPI data 306 comprises calculating the one or more KPI values for the PID controller using at least a portion of the plant data 302 (e.g., at least a portion of the PID controller data 304 thereof). For example, the system 103 may calculate one or more KPI values for the PID controller based on at least a portion of the PID controller data 304 for the PID controller.

In some embodiments, generating the KPI data 306 comprise extracting the one or more KPIs from the plant data 302. For example, the PID controller data 304 may comprise calculated KPI values for one or more KPIs for the PID controller. In some embodiments, the system 103 extracts the one more KPIs from the plant data 302 using a data extraction model.

In various embodiments, performance diagnostic data 310 is generated for the PID controller based on the KPI data 306 for the PID controller and threshold data 308 corresponding to the KPI data 306. In various embodiments, the performance diagnostic data 310 comprises fault data 312 (e.g., detect fault(s)) for the PID controller. In various embodiments, the fault data 312 comprises, or otherwise indicates, one or more faults associated with the PID controller. In various embodiments, the system 103 analyzes the KPI data 306 to determine if the PID controller is associated with a fault(s) and/or type of fault(s). Additionally, in some embodiments, the performance diagnostic data 310 comprises one or more solutions (solutions data 314) for resolving a detected fault for the PID controller. For example, the system 103 may be configured to determine at least one solution for resolving an identified fault associated with the PID controller. In various embodiments, at least a portion of the performance data (e.g., detected fault and/or solution) may be presented to a user via, for example, a user interface. For example, a notification and/or an alert comprising the data that describes the fault and/or the solution(s) may be caused to be rendered on a user interface.

In various embodiments, the system 103 leverages a performance analysis model to generate the performance diagnostic data 310. In various embodiments, the system 103 may be configured to execute a performance analysis model (e.g., at least one algorithm thereof) to generate the KPI data 306 by applying the KPI data to the performance analysis model. In various embodiments, the performance analysis model is configured, trained, and/or the like to receive the KPI data 306 as input and analyze the KPI data 306 with respect to at least a portion of threshold data 308 associated with the PID controller KPIs. In various embodiments, the threshold data 308 comprises threshold values (e.g., limits such as upper limits, lower limits, range and/or the like) for one or more PID controller KPIs. In some embodiments, the limits are configurable. Alternatively or additionally, in some embodiments, the limits are user-defined limits.

In various embodiments, the performance analysis model comprises one or more algorithms configured for generating the performance diagnostic data 310. In various embodiments, the performance analysis model (e.g., at least one algorithm thereof) defines one or more performance diagnosis rules. In various embodiments, each performance diagnosis rule comprises one or more conditions that are evaluated for the PID controller. Each performance diagnosis rule may comprise a set of one or more KPIs and corresponding thresholds (e.g., limits). A given KPI and corresponding threshold may represent a condition to be evaluated such that executing the performance analysis model to generate the performance diagnostic data 310 may comprise evaluating each KPI in the set of one or more KPIs against the corresponding threshold (e.g., comparing each KPI in the set of one or more KPIs to the corresponding threshold). In various embodiments, each performance diagnosis rule is associated with a particular type of fault (or performance level). For example, certain combination of KPI values for a PID controller (alone or along with certain other conditions for the PID controller) may indicate that the PID controller is associated with a particular type of fault. In some embodiments, one or more of the performance diagnosis rules may comprise a single KPI and corresponding threshold with or without other conditions. In various embodiments, one or more of the performance diagnosis rules may include other conditions that are not KPIs.

The system 103, using the performance analysis model, may be configured to apply the KPI data 306 to at least one performance diagnosis rule from the one or more performance diagnosis rules to generate the performance diagnostic data 310. The system 103 (e.g., using the performance analysis model) may be configured to determine that the PID controller is associated with a particular fault (or performance level) in response to determining that the PID controller satisfies a performance diagnosis rule associated with the particular fault. In various embodiments, applying the KPI data 306 to a performance diagnosis rule comprises evaluating each condition defined by the performance diagnosis rule to determine if the condition is satisfied. In various embodiments, this includes evaluating the PID controller KPI value for each KPI in the performance diagnosis rule against the corresponding threshold value (e.g., limits) in the performance diagnosis rule to determine (e.g., comparing the PID controller KPI value for each KPI defined by the performance diagnosis rule to the corresponding threshold value (e.g., limits) defined by the performance diagnosis rule). In various embodiments, the system 103, in response to determining that each of the conditions in a performance diagnosis rule is satisfied, generates performance data that comprises the fault (or performance level) and/or solution(s) associated with the particular performance diagnosis rule. The performance analysis model may identify, from the KPI data 306, one or more sets of KPI values corresponding to a particular performance diagnosis rule defined by the performance analysis model. For example, each set of KPI values may comprise one or more KPI values for the PID controller that correspond to the one or more KPIs defined by at least one performance diagnosis rule. In various embodiments, the performance analysis model is configured to evaluate at least one set of KPI values against the corresponding set of threshold values and determine based on at least each evaluation whether the PID controller is associated with a fault(s) and type of fault. For the performance analysis model may be configured to compare at least one set of KPI values to the corresponding set of threshold values and determine based on each comparison whether the PID controller is associated with a fault(s) and type of fault

In various embodiments, the threshold data 308 represents model features for the performance analysis model. For example, the performance analysis model may be generated, configured, trained, and/or the like based at least in part on the threshold data 308. In some embodiments the threshold data 308 is obtained from one or more repositories. For example, in some embodiments, the threshold data 308 may be retrieved from one or more repositories. In some embodiments, such repositories may be associated with the process control and automation system (e.g., such as process control automation system 104) associated with PID controller. For example, the process control and automation system may include one or more repositories comprising threshold data for PID controllers associated with the process control and automation system. In some embodiments, the one or more repositories may be external to the process control and automation system.

FIG. 4a illustrates an operational example of performance diagnosis classification categories and related features in accordance with at least one example embodiment of the present disclosure. In particular, FIG. 4a shows example performance diagnosis rules 404 (e.g., 404a-n) defined at least in part by one or more KPIs and corresponding thresholds (e.g., limits) and example performance diagnostic data 406 (e.g., 406a-n) based on the example performance diagnosis rules 404.

In some embodiments, the one or more performance analysis models comprise one or more rules-based models. In some embodiments, the one or more performance analysis models comprise one or more machine learning models. In some embodiments, a performance analysis model may be generated, trained, validated, and/or tested based on training data that comprises past PID controller data (e.g., historical PID controller data) associated with a plurality of PID controllers and corresponding threshold data for the past PID controller data. For example, in various embodiments, past PID controller data 304 for a plurality of PID controllers is aggregated or otherwise obtained from one or more data sources. Such data sources may comprise repositories (e.g., database and/or the like) associated with one or more process plants. In various embodiments, the aggregated past PID controller data may be preprocessed, sampled, and/or the like to generate training data for the performance analysis model. In some embodiments, at least a portion of the training data may be used to validate and/or test the performance analysis model.

In some embodiments, performance issue classification 316 (e.g., fault classification) for the PID controller is generated based on the performance diagnostic data 310 for the PID controller. In some embodiments, the system 103 leverages the performance analysis model to generate the performance issue classification for the PID controller. For example, the performance analysis model may include one or more classification algorithms configured for classifying the performance issue associated with the PID controller. In some embodiments, the system 103 may leverage other models (e.g., other rules-based or machine learning models) to generate the performance issue classification for the PID controller.

In some embodiments, generating the performance issue classification 316 for the PID controller comprises assigning the PID controller to at least one pre-defined performance issue category of a plurality of pre-defined performance issue categories based on the performance diagnostic data 310 for the PID controller. For example, a performance analysis model may be associated with a performance issue classification space comprising one or more pre-defined performance issue categories for which a PID controller may be classified. Non limiting examples of performance issue categories 408 (e.g., fault categories) are shown in FIG. 4a. Such non limiting example performance issue categories 408 include offset, over-tuned, sluggish, sticky, high wear and tear, oversize, undersize low SF, low percent, saturated, compressed, oscillatory, and noisy.

Referring to FIG. 3, in various embodiments, performance rating data 318 is generated for the PID controller based on the KPI data 306 for the PID controller and threshold data 308. In various embodiments, generating the performance rating data 318 comprises evaluating one or more conditions. In various embodiments, at least one condition may be defined by one or more KPIs and corresponding threshold, such that evaluating a condition may comprise evaluating at least one or more KPIs for the PID controller against the corresponding thresholds to determine if the condition is satisfied. In some embodiments, the system 103 leverages the performance analysis model to generate the performance rating data. The performance analysis model may be configured to evaluate a set of KPI values for the PID controller against a corresponding set of threshold values to generate the performance rating data 318. For example, the performance analysis model may be configured to compare a set of KPI values for the PID controller to a corresponding set of threshold values to generate the performance rating data 318. In various embodiments, the performance rating data 318 comprises data that describes, whether a particular condition is satisfied by the PID controller. For example, the performance rating data 318 may comprise data that describes, for each KPI in the set of KPIs, whether the PID controller is within pre-defined limits for the KPI. In an example embodiments, the performance rating data includes an indication that a particular condition is satisfied by the PID controller. Non-limiting examples of such indication include “True” for a condition that is satisfied and “False” for a condition that is not satisfied. For example, in an example embodiment, the performance rating data 318 includes an indication of “True” for a KPI within the corresponding pre-defined limits and an indication of “False” for a KPI that is not within the corresponding pre-defined limits. It would be appreciated that other indications may be used. In some embodiments, the system 103 may leverage other models (e.g., other rules-based or machine learning models) to generate the performance rating data 318 for the PID controller.

FIG. 4b illustrates an operational example of performance rating classification categories and related features in accordance with at least one example embodiment of the present disclosure. In particular, FIG. 4b shows example conditions 420a-n and example performance rating data 422a-n comprising indication of whether a given condition is satisfied by the PID controller. For example, in the illustrated example, for a first PID controller, the performance rating data 422a comprises True for a first condition 420a, True for a second condition 420b, and True for a third condition 420c. Further, in the illustrated example, for a second PID controller, the performance rating data 422b comprises False for a first condition 420a, True for a second condition 420b, and Truc for a third condition 420c.

The set of KPI values and set of threshold values used to generate the performance rating data 318 may be different from the set of KPI values and set of threshold values used to generate the performance diagnostic data 310. For example at least a portion of the set of KPI values and set of threshold values used to generate the performance rating data 318 may be different from the set of KPI values and set of threshold values used to generate the performance diagnostic data 310. In some embodiments, the KPIs leveraged to generate the performance rating data 318 may be the same as those used to generate the performance diagnostic data 310.

In some embodiments, performance rating classification 320 for the PID controller is generated based on the performance rating data 318 for the PID controller. In some embodiments, the system 103 leverages the performance analysis model to generate the performance rating classification 320 for the PID controller. For example, the performance analysis model may include one or more classification algorithms configured for classifying a PID controller based on the performance rating data 318 for the PID controller. As shown in the operational example of FIG. 4b, certain combination of performance KPI values may be associated with a particular rating classification category of a plurality of performance rating categories. The system 103 (e.g., using the performance analysis model) may be configured to, in response to determining that the performance rating data 318 corresponds to a particular combination of KPI values, determine the performance rating classification for the PID to be the performance rating category associated with the particular combination of KPI values. For example, the system 103 (e.g., using the performance analysis model) may be configured to determine the performance rating classification for a PID controller based on the result of the evaluation of each of one or more conditions (e.g., 420a-n in the illustrated example of FIG. 4b)/

In some embodiments, generating the performance rating classification 320 for the PID controller comprises assigning the PID controller to one or more of a plurality of pre-defined performance rating categories based on the performance rating data 318 for the PID controller. For example, the performance analysis model may be associated with a performance rating classification space comprising one or more pre-defined performance rating categories for which a PID controller may be assigned (e.g., classified). As shown in FIG. 4b, non-limiting examples of performance rating categories 424 include open loop, excellent, good, fair, and/or poor. It would be appreciated that the performance rating categories can include other categories and/or omit some of the performance rating categories illustrated in the example of FIG. 4b or include other types of categories.

In some embodiments, an improvement action is generated for the PID controller based on the performance issue classification 316 and/or the performance rating classification 320 for the PID controller. In some embodiments, generating the improvement action comprises assigning the PID controller to a PID controller category 324 based on the performance issue classification 316 and the performance rating classification 320. For example, in various embodiments, each PID controller category 324 of a plurality of controller categories correspond to or otherwise describes a particular improvement action. For example, each PID controller category may be defined by an improvement action such that PID controllers that are assigned to the PID controller category comprise PID controllers that are associated with such improvement actions based on the performance issue classification 316 and the performance rating classification 320 for the PID controller. Non-limiting examples of PID controller categories (e.g., improvement action) include “tune”, “fix”, and “investigate”.

The system 103 may be configured to determine a PID controller category for the PID controller based on the performance issue classification 316 and the performance rating classification 320, wherein each PID controller category is defined by a corresponding improvement action. In some embodiments, the system 103 leverages the performance analysis model to determine the PID controller category for the PID controller. For example, in some embodiments, the performance analysis model may include one or more algorithms that include performance issue classification and performance rating classification as features for determining the PID controller category (e.g., improvement action) for the PID controller.

In some embodiments, the performance analysis model defines one or more PID controller categorization rules based at least in part on performance rating classification and performance issue classification. Each PID controller categorization rule is associated with a particular PID controller category. In various embodiments, the system 103 (e.g., using a performance analysis model or other model) is configured to apply the performance rating classification and performance issue classification for the PID controller to at least one PID controller categorization rule and determine if the PID controller categorization rule is satisfied. Each PID controller categorization rule may comprise one or more conditions. In some embodiments, each condition may be defined at least in part by performance rating classification and performance issue classification such that determining the PID controller category (e.g., improvement action category) for a PID controller may comprise evaluating the performance rating classification and performance issue classification for the PID controller to determine if satisfies the conditions. In response to determining that the PID controller categorization rule is satisfied, the system 103 may assign the PID controller to a corresponding PID controller category associated with the PID categorization rule. In some embodiments, the system 103 may leverage other models (e.g., other rules-based or machine learning models) to generate the PID controller category.

FIG. 4c is illustrates an operational example of PID controller categories and related features in accordance with at least one example embodiment of the present disclosure. In particular, FIG. 4c shows example PID categorization rules 456 defined at least in part by performance issue classifications and performance rating classifications and example PID controller category 452 and sub-category 454 (e.g., performance diagnosis classification in the illustrated operational example). In such example, the system 103 may be configured to apply the performance rating classification and performance issue classification for the PID controller to at least one of the PID categorization rules rules 456 to determine the PID controller category (e.g., improvement action) for the PID controller.

In some embodiments, performance of one or more prediction-based operations is initiated based on one or more of the PID controller category (e.g., improvement action) for at least one PID controller of the one or more PID controllers associated with a process plant or the enterprise system.

In some embodiments, initiating the performance of one or more prediction-based operations comprises generating statistical data for each PID controller category of the plurality of Controller categories based on the PID controllers assigned to each PID controller category, and causing rendering of a user interface comprising the statistical data. The statistical data may be generated at the various levels associated with the enterprise system. For example, in some embodiments, the statistical data may comprise one or more of unit-level statistical data, plant-level statistical data, site-level statistical data, or enterprise-level statistical data. In an example embodiment, the statistical data for a given PID controller category comprises one or more of a count and/or percentage of PID controllers in the PID controller category, a count and/or percentage of PID controllers associated with a particular performance issue classification, or a count and/or percentage of PID controllers associated with a particular performance rating classification.

In some embodiments, initiating performance of one or more prediction-based operations comprises automatically adjusting one or more parameters of at least one PID controller based on the PID controller category (e.g., improvement action defined thereby) determined for the at least one PID controller. In some embodiments, initiating performance of one or more prediction-based operations comprises automatically adjusting one or more parameters of at least one APC controller and/or PWO associated with the PID controller based on the PID controller category (e.g., improvement action defined thereby) determined for the at least one PID controller. In some embodiments such automatic adjustments may comprise modifying the PID controller, Unit, APC, PWO, and/or the like based on the PID controller category (e.g., improvement action defined thereby). In some embodiments, initiating performance of one or more prediction-based operations comprises automatically adjusting one or more parameters of at least one unit (e.g., processing unit) associated with the PID controller based on the PID controller category (e.g., improvement action defined thereby) determined for the at least one PID controller. In some embodiments, the unit may comprise one or more equipment whose parameters are automatically adjusted. In some embodiments, initiating the performance of one or more prediction-based operations comprises generating and providing one or more notifications to a user. The one or more notifications may comprise a recommended corrective action for resolving a particular fault/issue associated with a PID controller based on the performance issue classification for the PID controller.

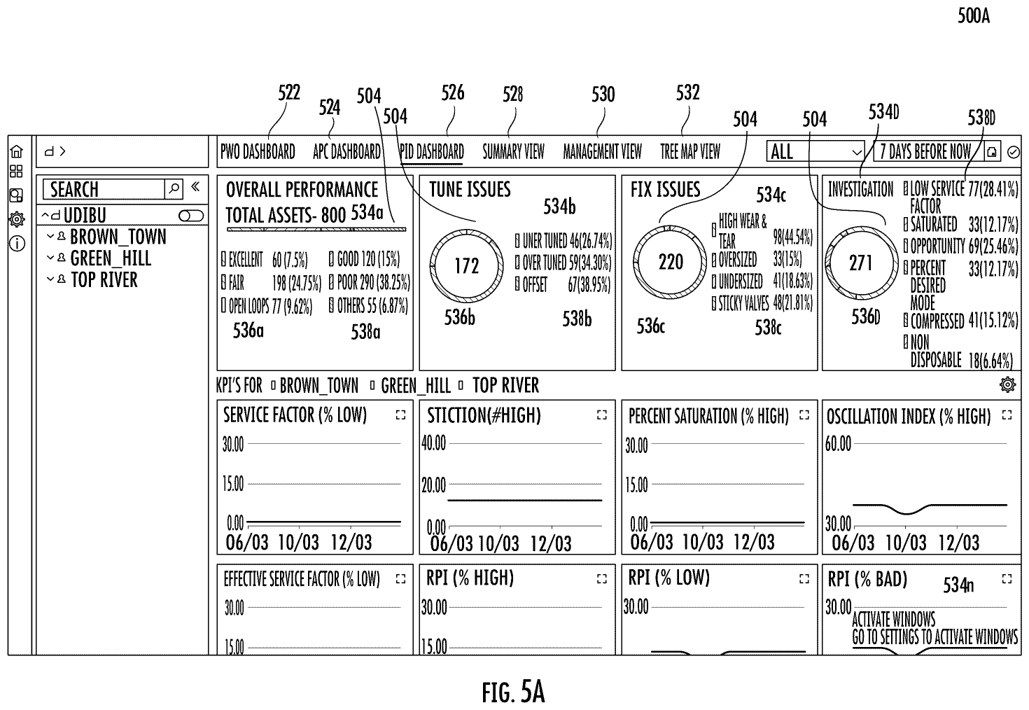

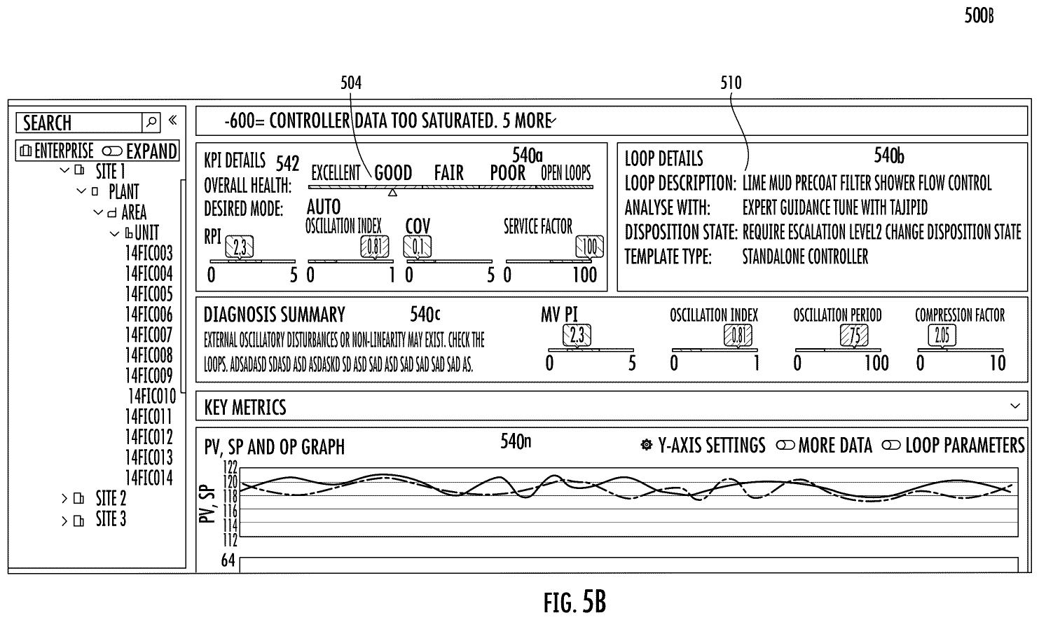

FIGS. 5a and 5b each illustrate an example user interface according to at least one example embodiment of the present disclosure. The user interfaces may be configured to show data associated with PID controllers at various levels for an enterprise (e.g., enterprise level, site level, process plant level, area level, unit level, and/or the like). Specifically, FIG. 5a shows example user interface 500a configured for presenting a visualization of categories of PID controllers associated with a process plant (or group of process plants) associated with an enterprise. For example, user interface 500a may provide a diagnostic category integration view accessible via the view selection element PID Dashboard 526 of the user interface 500a. For example, the diagnostic category integration view shown in FIG. 5a may be rendered in response to selection of PID dashboard 526. As shown in FIG. 5a, user interface 500a may include other interface view selection elements (e.g., PWO dashboard 522, APC dashboard 524, summary view 528, management view 530, tree map view 532, and/or the like) for accessing other views. The diagnostic categorization integration view may define a plurality of graphical tiles (532a-n). At least a portion of the graphical tiles may be configured to present data associated with a particular PID controller category (e.g., defined by the improvement action for the PID controllers in that PID controller category). In particular, in the illustrated example, graphical tile 534a presents one or more representations of the overall performance of the PID controllers and graphical tiles 534b-d each present one or more representations of data associated with a particular PID controller category (e.g., tune, fix, investigation). As shown in FIG. 5a, the user interface 500a may comprise one or more representations 504 of the statistical data for a PID controller category at a particular hierarchical level of the enterprise. In the illustrated example, graphical tiles 534b-d, each present representations of statistical data for a PID controller category that comprises the total number and/or percentage of PID controllers in the respective PID controller category (e.g., 536b-d)) and the total number and/or percentage of PID controllers in each respective sub-category (e.g., 538b-d). In the illustrated example, graphical tile 534a presents representations of statistical data for all the PID controllers that comprises the overall performance of all the PID controllers (e.g., 536a) and the total number and/or percentage of PID controllers in each performance rating category (e.g., 536b).

FIG. 5b shows example user interface 500b configured for presenting a visualization of performance rating and solutions (e.g., recommended actions to resolve detected faults) for PID controllers associated with a process plant (or group of process plants) associated with an enterprise. In particular, FIG. 5b shows example user interface 500b presenting a visualization of performance rating and solutions for a PID controller associated with a particular unit of a particular process plant. For example, user interface 500b may provide a performance rating integration view showing the data for a particular PID controller. The performance rating integration view may define a plurality of graphical tiles (540a-n). In the illustrated example, graphical tile 540a presents one or more representations of the overall health 542 (e.g. performance rating classification) of a particular PID controller. Graphical tile 540b may represent a notification 510 (e.g., or alert) for a user describing detect fault, solution, and/or the like for the PID controller. For example, graphical tile 540b may comprise a textual representation that includes description of the PID controller, analysis information for the PID controller, disposition state for the PID controller, and template type for the PID controller. Graphical tile 540c presents representations of diagnosis (e.g., diagnosis summary) for the PID controller.

### Example Processes of the Disclosure

Having described example systems and apparatuses, AND data visualizations in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depicts a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

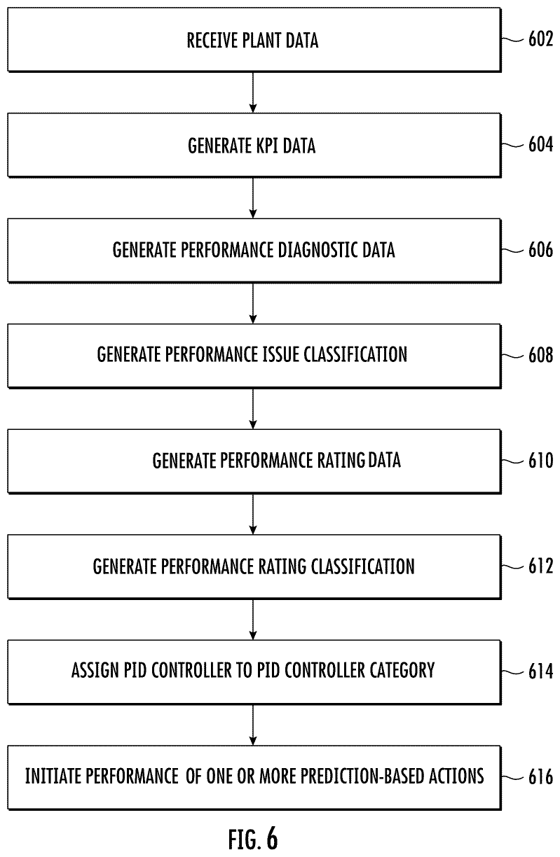

FIG. 6 illustrates a flowchart including operations of an example process for categorizing PID controller performance in accordance with at least one example embodiment of the present disclosure. In some embodiments, the process 600 is embodied by computer program code stored on a non-transitory computer-readable storage medium of a computer program product configured for execution to perform the process as depicted and described. Alternatively or additionally, in some embodiments, the process 600 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with separate component(s) of a network, external network(s), and/or the like, to perform one or more of the operation(s) as depicted and described. For purposes of simplifying the description, the process 600 is described as performed by and from the perspective of the apparatus 200.

Although the example process 600 depicts a particular sequence of operations, the sequence may be altered without departing from the scope of the present disclosure. For example, some of the operations depicted may be performed in parallel or in a different sequence that does not materially affect the function of the process 600. In other examples, different components of an example device or system that implements the process 600 may perform functions at substantially the same time or in a specific sequence.

According to some examples, the method includes at operation 602, receiving plant data associated with one more process plants. For example, the apparatus 200 may receive plant data associated with a process plant. In various embodiments, at least a portion of the plant data 302 comprises PID controller data for each of one or more PID controllers associated with a process plant.

According to some examples, the method includes at operation 604, generating KPI data for the PID controller. For example, the apparatus 200 may generate KPI data for one or more PID controllers. In various embodiments, the KPI data for the PID controller is generated based on the plant data (e.g., PID controller data thereof). In various embodiments, the KPI data comprises one or more calculated KPIs values for the PID controller (e.g., KPI values for one or more KPIs). In some embodiments, generating the KPI data comprises calculating the one or more KPIs for the PID controller using at least a portion of the plant data (e.g., at least a portion of the PID controller data thereof). For example, the one or more KPIs may be calculated for the PID controller based on at least a portion of the PID controller data for the PID controller. In some embodiments, generating the KPI data comprise extracting the one or more KPIs from the plant data. For example, in some embodiments, the PID controller data may comprise KPI values for one or more KPIs for the PID controller. Non-limiting examples of KPIs for a PID controller include compression factor, oscillation index (OI), set point (SP) changes, relative performance index, percent saturation, service factor (SF), effective service factor (ESF), stiction, and/or the like.

According to some examples, the method includes at operation 606, generating performance diagnostic data for the PID controller based on the KPI data for the PID controller and corresponding threshold data. For example, the apparatus 200 may generate performance diagnostic data for one or more PID controllers. In various embodiments, the performance diagnostic data comprises fault data (e.g., detect fault(s)) for the PID controller. In various embodiments, the fault data comprises, or otherwise indicates, one or more faults associated with the PID controller. Additionally, in some embodiments, the diagnostic data comprises one or more solutions (e.g., recommend solutions) for resolving a detected fault for the PID controller. For example, one or more solutions are generated for a fault associated with the PID controller. In various embodiments, the threshold data comprises limits (e.g., upper limits, lower limits, limit range, or the like) for one or more KPIs for the PID controller.

In various embodiments, the performance diagnostic data is generated using a performance analysis model configured, trained, and/or the like to receive the KPI data as input and analyze the KPI data 306 with respect to the threshold data. In various embodiments, the performance analysis model comprises one or more algorithms. In various embodiments, the performance analysis model (e.g., at least one algorithm thereof) defines one or more performance diagnosis rules. Each performance diagnosis rule may comprise a set of one or more KPIs and corresponding thresholds (e.g., limits). In various embodiments, each performance diagnosis rule is associated with a particular type of fault. For example, certain combination of KPI values for a PID controller may indicate that the PID controller is associated with a particular type of fault. The apparatus 200 may determine that the PID controller is associated with a particular fault in response to determining that the PID controller KPI values satisfy a performance diagnosis rule associated with the particular fault.

According to some examples, the method includes at operation 608, generating performance issue classification for the PID controller based on the performance diagnostic data for the PID controller. For example, the apparatus 200 may generate performance diagnostic data for one or more PID controllers using a performance analysis model. In some embodiments, generating the performance issue classification for the PID controller comprises assigning the PID controller to one or more of a plurality of pre-defined performance issue categories based on the performance diagnostic data for the PID controller. Non limiting examples of performance issue categories include offset, over-tuned, sluggish, sticky, high wear and tear, oversize, undersize low SF, low percent, saturated, compressed, oscillatory, and noisy.

According to some examples, the method includes at operation 610, generating performance rating data for the PID controller based on the KPI data for the PID controller and threshold data. In some embodiments, the apparatus 200 leverages a performance analysis model to generate the performance rating data. The performance analysis model may be configured to compare a set of KPI values for the PID controller to a corresponding set of threshold values to generate the performance rating data. The set of KPI values and set of threshold values used to generate the performance rating data may be different from the set of KPI values and set of threshold values used to generate the performance diagnostic data. For example at least a portion of the set of KPI values and set of threshold values used to generate the performance rating data may be different from the set of KPI values and set of threshold values used to generate the performance diagnostic data.

According to some examples, the method includes at operation 612 generating performance rating classification for the PID controller based on the performance rating data for the PID controller. In some embodiments, the apparatus 200 leverages a performance analysis model configured to generate the performance rating classification for the PID controller. For example, the performance analysis model may include one or more classification algorithms configured for classifying a PID controller based on the performance rating data for the PID controller.

According to some examples, the method includes at operation 614, assigning the PID controller to a PID controller category of a plurality of controller categories based on the performance issue classification and the performance rating classification for the PID controller. In some embodiments, the performance analysis model may be leveraged to determine the PID controller category for the PID controller. In some embodiments, the performance analysis model defines one or more PID categorization rules based at least in part on performance rating classification category and performance issue classification category. Each rule may comprise a certain combination of performance rating classification and performance issue classification that is indicative of a particular PID controller category of the plurality of Controller categories. Non-limiting examples of Controller categories include “tune”, “fix”, and “investigate”. The apparatus 200 may be configured to, in response to determining that the performance rating classification and performance issue classification for a PID controller satisfies a particular PID categorization rule, assign the PID controller to the PID controller classification associated with the PID categorization rule.

According to some examples, the method includes at operation 616, initiating the performance of one or more prediction-based operations based on one or more the PID controller category (e.g., improvement action defined thereby) for at least one PID controller of the one or more PID controllers associated with a process plant or the enterprise system.

In some embodiments, initiating the performance of one or more prediction-based operations comprises generating statistical data for each PID controller category of the plurality of controller categories based on the PID controllers assigned to each PID controller category, and causing rendering of a user interface comprising the statistical data. The statistical data may be generated at the various levels associated with the enterprise system. For example, in some embodiments, the statistical data may comprise one or more of unit-level statistical data, plant-level statistical data, site-level statistical data, or enterprise-level statistical data. In an example embodiment, the statistical data for a given PID controller category comprises one or more of a count and/or percentage of PID controllers in the PID controller category, a count and/or percentage of PID controllers associated with a particular performance issue classification, or a count and/or percentage of PID controllers associated with a particular performance rating classification.

In some embodiments, initiating performance of one or more prediction-based operations comprises automatically adjusting one or more parameters of at least one PID controller based on the PID controller category (e.g., improvement action defined thereby) determined for the at least one PID controller. In some embodiments, initiating the performance of one or more prediction-based operations comprises generating and providing one or more notifications to a user. The one or more notifications may comprise a recommended corrective action for resolving a particular fault/issue associated with a PID controller based on the performance issue classification for the PID controller.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for categorizing PID controller performance, the computer-implemented method comprising:
generating, by one or more processors and using a performance analysis model, performance diagnostic data for a PID controller by applying KPI data for the PID controller to one or more performance diagnosis rules, wherein each performance diagnosis rule is defined at least in part by one or more threshold values for one or more KPIs for the PID controller;
generating, by the one or more processors, performance issue classification for the PID controller based on the performance diagnostic data;
generating, by the one or more processors, performance rating classification for the PID controller based on performance rating data for the PID controller by applying the performance rating data to one or more performance rating classification rules;
generating, by the one or more processors, an improvement action for the PID controller based on the performance issue classification and the performance rating classification for the PID controller by applying the performance issue classification and the performance rating classification to one or more PID categorization rules, wherein the improvement action corresponds to a PID controller category of a plurality of Controller categories; and
initiating, by the one or more processors, performance of one or more prediction-based actions based on the improvement action.

2. The computer-implemented method of claim 1, further comprising:
receiving plant data from one or more process plants, the plant data comprising PID data for the PID controller; and
generating the KPI data for the PID controller based on the PID data.

3. The computer-implemented method of claim 2, further comprising:
generating the performance rating data for the PID controller by comparing each of one or more KPI values from the KPI data to a corresponding threshold value.

4. The computer-implemented method of claim 2, wherein the performance diagnostic data for the PID controller comprises one or more detected faults associated with PID controller.

5. The computer-implemented method of claim 4, wherein the performance analysis model comprises a rules-based model.

6. The computer-implemented method of claim 1, wherein the improvement action is generated using the performance analysis model, where the performance analysis model defines the one or more PID categorization rules.

7. The computer-implemented method of claim 1, wherein the PID controller is associated with one or more of an APC controller or a PWO controller.

8. The computer-implemented method of claim 1, wherein initiating performance of one or more prediction-based operations comprises automatically adjusting one or more of (i) one or more parameters associated with the PID controller, (ii) one or more parameters associated with the APC controller, or one or more parameters associated with the PWO controller.

9. The computer-implemented method of claim 1, wherein initiating the performance of one or more prediction-based operations comprises generating statistical data for each PID controller category of the plurality of Controller categories based on the PID controllers assigned to each PID controller category; and
causing rendering of a user interface comprising one or more representation of the statistical data.

10. The computer-implemented method of claim 1, wherein the PID controller is associated with one or more processing units and initiating the performance of one or more prediction-based actions comprises automatically adjusting one or more parameters associated with the processing unit, wherein the processing unit comprises one or more equipment.

11. An apparatus comprising at least one processor and at least one memory storing instructions that, when executed by the at least one processor, cause the apparatus to:
generate, using a performance analysis model, performance diagnostic data for a PID controller by applying KPI data for the PID controller to one or more performance diagnosis rules, wherein each performance diagnosis rule is defined at least in part by one or more threshold values for one or more KPIs for the PID controller;
generate performance issue classification for the PID controller based on the performance diagnostic data;
generate performance rating classification for the PID controller based on performance rating data for the PID controller by applying the performance rating data to one or more performance rating classification rules;
generate an improvement action for the PID controller based on the performance issue classification and the performance rating classification for the PID controller by applying the performance issue classification and the performance rating classification to one or more PID categorization rules, wherein the improvement action corresponds to a PID controller category of a plurality of Controller categories; and
initiate performance of one or more prediction-based actions based on the improvement action.

12. The apparatus of claim 11, further comprising:
receiving plant data from one or more process plants, the plant data comprising PID data for the PID controller; and
generating the KPI data for the PID controller based on the PID data.

13. The apparatus of claim 12, further comprising:
generating the performance rating data for the PID controller by comparing each of one or more KPI values from the KPI data to a corresponding threshold value.

14. The apparatus of claim 11, wherein the performance diagnostic data for the PID controller comprises one or more detected faults associated with PID controller.

15. The apparatus of claim 14, wherein the performance analysis model comprises a rules-based model.

16. The apparatus of claim 11, wherein the improvement action is generated using the performance analysis model, where the performance analysis model defines the one or more PID categorization rules.

17. The apparatus of claim 11, wherein the PID controller is associated with one or more of an APC controller or a PWO controller.

18. The apparatus of claim 11, wherein initiating performance of one or more prediction-based operations comprises automatically adjusting one or more of (i) one or more parameters associated with the PID controller, (ii) one or more parameters associated with the APC controller, or one or more parameters associated with the PWO controller.

19. The apparatus of claim 11, wherein initiating the performance of one or more prediction-based operations comprises generating statistical data for each PID controller category of the plurality of Controller categories based on the PID controllers assigned to each PID controller category; and
causing rendering of a user interface comprising one or more representation of the statistical data.

20. At least one non-transitory computer-readable storage medium having computer coded instructions configured to, when executed by at least one processor:
generate, using a performance analysis model, performance diagnostic data for a PID controller by applying KPI data for the PID controller to one or more performance diagnosis rules, wherein each performance diagnosis rule is defined at least in part by one or more threshold values for one or more KPIs for the PID controller;
generate performance issue classification for the PID controller based on the performance diagnostic data;
generate performance rating classification for the PID controller based on performance rating data for the PID controller by applying the performance rating data to one or more performance rating classification rules;
generate an improvement action for the PID controller based on the performance issue classification and the performance rating classification for the PID controller by applying the performance issue classification and the performance rating classification to one or more PID categorization rules, wherein the improvement action corresponds to a PID controller category of a plurality of Controller categories; and
initiate performance of one or more prediction-based actions based on the improvement action.
